(19) United States
(12) Patent Application Publication
(10) Pub. No.: US 2015/0050470 A1
(43) Pub. Date: Feb. 19, 2015

(54) IN-MOLD TRANSFER FILM AND METHOD FOR FABRICATING THE SAME

(71) Applicant: LG HAUSYS, LTD., Seoul (KR)

(72) Inventors: Sang Hui Han, Ulsan (KR); Hyung Gon Kim, Ulsan (KR); Seung Hun Lee, Cheongju-si (KR)

(21) Appl. No.: 14/385,697

(22) PCT Filed: Mar. 18, 2013
(86) PCT No.: PCT/KR2013/002205

§ 371 Date: Sep. 16, 2014

(30) Foreign Application Priority Data
Mar. 19, 2012 (KR) 10-2012-0027595

(51) Int. Cl. B29C 45/14; B05D 7/00

(52) U.S. Cl. CPC B29C 45/14688; B05D 7/58; B29L 2009/005
USPC 428/201; 428/353; 428/336; 427/207.1

(57) ABSTRACT

The present invention relates to a method for fabricating an in-mold transfer film, including the steps of: forming a substrate layer with any one of PVC, PET, and PETG; forming a hard coating layer having a given release force on top of the substrate layer; coating a primer layer on top of the hard coating layer so as to strengthen the bonding force between the hard coating layer and a printing layer to be formed on the primer layer; and forming the printing layer on top of the printer layer; and coating an adhesive layer on top of the printing layer.

### TECHNICAL FIELD

The present invention relates to an in-mold transfer film and a method for fabricating the same, and more particularly, to an in-mold transfer film and a method for fabricating the same that are capable of removing a process for forming a releasing layer at the time of fabricating a transfer film, thereby decreasing the number of the fabricating processes, protecting the damages of a substrate layer caused by the working under a high temperature and protecting consecutive changes of releasing layer.

### BACKGROUND ART

In general, in-mold injection has been widely used to make front panels of all kinds of home appliances like washing machines, air conditioners and so on and to make the LCD windows and keypads of computers, cellular phones and so on.

The in-mold injection is conducted by performing melted resin injection in a state where a transfer film on which a given design has been printed is mounted between a fixed frame and a moving frame of an injection mold, thereby achieving the transfer in the direction of 360° and in the uneven portion which has been not solved in the existing thermal transfer method. Through the in-mold injection, further, the design printed on the transfer film is transferred to the surface of a molded product, at the same time when the injection is performed. If such in-mold injection is applied, four steps including injection, vacuum deposition, adhesion and aluminum plate attachment in the conventional practice can be reduced to a single step where the injection and transfer have been at the same time performed, thereby advantageously decreasing the fabricating cost of the molded product and greatly lowering a defect rate of the molded product.

A component, which gives many influences on the quality of the molded product in the in-mold injection, is the transfer film. The transfer film typically includes a substrate layer having a release force, a surface protection layer formed on top of the substrate layer, a printing layer having a given design formed on top of the surface protection layer, and an adhesive layer formed on top of the printing layer. If the injection process is finished, the surface protection layer and the printing layer are transferred to the molded product by means of the adhesive layer, and the substrate layer is separated and removed. At this time, only the portion of the surface protection layer covering the printing layer is attached on the molded product, and the other portion thereof is removed together with the substrate layer being separated.

Like this, the conventional in-mold transfer film has a release agent coated between the substrate layer and the surface protection layer so as to transfer the printed design onto the molded product, thereby ensuring the release force at the time of the injection molding.

In case of the conventional in-mold transfer film, however, the substrate layer may be damaged due to the working under a high temperature for release agent coating, and further, the releasing layer may have consecutive changes with the passage of time.

### DISCLOSURE OF INVENTION

### Technical Problem

Accordingly, the present invention has been made in view of the above-mentioned problems occurring in the prior art, and it is an object of the present invention to provide an in-mold transfer film and a method for fabricating the same that are capable of removing a process for forming a releasing layer at the time of fabricating a transfer film, thereby decreasing the number of the fabricating processes protecting the damages and of a substrate layer caused by the working under a high temperature and protecting consecutive changes of releasing layer.

### SOLUTION TO PROBLEM

To accomplish the above object, according to the present invention, there is provided a method for fabricating an in-mold transfer film, including the steps of: forming a substrate layer with any one of PVC, PET and PETG; forming a hard coating layer having a given release force on top of the substrate layer; coating a primer layer on top of the hard coating layer so as to strengthen the bonding force between the hard coating layer and a printing layer to be formed on the primer layer; and forming the printing layer on top of the primer layer; and coating an adhesive layer on top of the printing layer.

According to the present invention, desirably, the hard coating layer includes a composition containing slip agent, wax, and inorganic matters to apply the given release force to the surface contacted with the substrate layer.

According to the present invention, desirably, the primer layer includes a composition containing one of acrylpolyol and urethane copolymer.

According to the present invention, desirably, the printing layer is formed by means of gravure printing and has a thickness between 1 μm and 5 μm.

According to the present invention, desirably, the adhesive layer is formed of a polyester adhesive and coated to a thickness between 1 μm and 5 μm.

According to the present invention, desirably, the in-mold transfer film manufactured according to any one of the above-mentioned methods.

### ADVANTAGEOUS EFFECTS OF INVENTION

According to the present invention, there are provided the in-mold transfer film and the method for fabricating the same that are provided with the hard coating layer to which the given release force is applied, so that even if no separate releasing layer is formed at the time of in-mold injection molding, the substrate layer is easily separated from the hard coating layer, thereby reducing the processes and costs needed for fabricating the in-mold transfer film.

### BRIEF DESCRIPTION OF DRAWINGS

FIG. 1 is a side sectional view showing the laminated structure of an in-mold transfer film according to the present invention.

FIG. 2 is a side sectional view showing the state where the in-mold transfer film is attached to an injection product through in-mold injection.

### MODE FOR THE INVENTION

Hereinafter, an explanation on an in-mold transfer film and a method for fabricating the same according to the present invention will be in detail given with reference to the attached drawings.

It should be noted that the parts corresponding to those in the description are indicated by corresponding reference numerals, even if they are indicated on different figures.

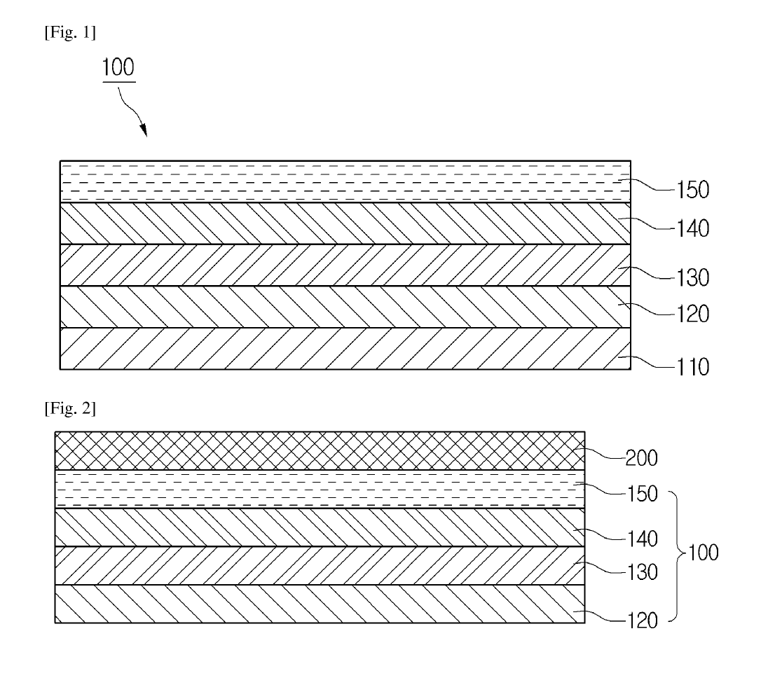

FIG. 1 is a side sectional view showing the laminated structure of an in-mold transfer film according to the present invention, and FIG. 2 is a side sectional view showing the state where the in-mold transfer film is attached to an injection product through in-mold injection.

Referring to FIG. 1, an in-mold transfer film 100 according to the present invention includes a substrate layer 110, a hard coating layer 120 formed on top of the substrate layer 110, a primer layer 130 coated on top of the hard coating layer 120, a printing layer 140 formed on the top of the primer layer 130, and an adhesive layer 150 coated on top of the printing layer 140.

Now, the configuration of the in-mold transfer film 100 according to the present invention will be explained in detail.

The substrate layer 110 serves as a base substrate of the in-mold transfer film, which supports a plurality of coating layers laminated on the top thereof and further maintains the bending balance of the upper and lower portion of the film 100 according to the present invention. The substrate layer 110 is made of any one of PVC, PET and PETG, and according to the present invention, preferably, it is made of PET (polyethylene terephthalate). Because the PET has strong tension force and excellent thermal stability, it exhibits high dimension stability and durability, which provides low changes in physical properties even after winding in several times. Further, the PET is easy to have physical treatment (corona) and chemical treatment (acryl, urethane) for increasing the attaching force of the surface and also has strong boning. Moreover, since the PET has excellent solvent resistance against organic solvent, it has easy physical properties in coating an organic solvent binder.

The hard coating layer 120 is formed on top of the substrate layer 110 and exposed to the outside when the substrate layer 110 is separated after the in-mold transfer film has been transferred, which serves to protect the surface of the film from scratching. In this case, preferably, the hard coating layer 120 includes a composition containing slip agent, wax, and inorganic matters to apply a given release force to the surface contacted with the substrate layer 110. Even if no separate releasing layer is formed on top of the substrate layer 110, accordingly, the substrate layer 110 can be easily separated from the hard coating layer 120 at the time of the in-mold injection molding.

The primer layer 130 is coated on top of the hard coating layer 120 and serves to strengthen the bonding force between the printing layer 140 to be formed thereon and the hard coating layer 120. Further, the primer layer 130 serves to improve the absorbing force of the ink used for the printing layer 140. That is, even though the hard coating layer 120 is capable of absorbing the ink, it has relatively low resolution and intensity, so that desirably, the primer layer 130 is separately formed. In this case, preferably, the primer layer 130 includes a composition containing one of acrylpolyol and urethane copolymer, which have excellent ink absorption.

The printing layer 140 is printed on top of the primer layer 130 by means of gravure printing and serves to provide a variety of designs, characters or trademarks with various colors.

The adhesive layer 150 is coated on top of the primer layer 130 and serves to increase the bonding force between the in-mold transfer film 100 and an injection product 200. In this case, preferably, the adhesive layer 150 is formed of a polyester adhesive.

Now, an explanation on the processes for fabricating the in-mold transfer film and for attaching the transfer film to the injection product will be given.

First, the substrate layer 110 is formed of any one of PVC, PET and PETG. At this time, desirably, the substrate layer 110 has a thickness between 25 μm and 50 μm. That is, if the thickness of the substrate layer 110 is less than 25 μm, cracks may occur due to the weight of the plurality of layers laminated on top of the substrate layer 110. To the contrary, if the thickness of the substrate layer 110 is more than 50 μm, the extension of the corners of the injection product 200 at the time of the injection process is low to cause the shape deformation, and further, feeding is not gentle to cause many defects to be generated.

Next, the hard coating layer 120 having the release force is formed on top of the substrate layer 110.

After that, the primer layer 130 including a composition containing one of acrylpolyol and urethane copolymer is coated on top of the hard coating layer 120 so as to strengthen the bonding force between the hard coating layer 120 and the printing layer 140 to be formed thereon.

The printing layer 140, which forms a variety of designs, characters or trademarks with various colors, is then printed on top of the primer layer 130. In this case, preferably, the printing layer 140 includes a composition containing 25 parts by weight of a pigment, 15 parts by weight of a synthetic resin, and 5 parts by weight of a curing agent and at this time, desirably, the curing agent includes a synthetic resin containing urethane copolymer of about 40%. Also, the printing layer 140 is formed by means of gravure printing and has a thickness between 1 μm and 5 μm.

Lastly, the polyester adhesive layer 150 is formed on top of the printing layer 140, which is coated to a thickness between 1 μm and 5 μm, thereby completing the fabricating of the in-mold transfer film 100.

Referring simply to the process for attaching the in-mold transfer film 100 to the injection product 200, first, the substrate layer 110 of the in-mold transfer film 100 is located in a lower mold (not shown) toward the interior of the lower mold. Next, an upper mold (not shown) is descended toward the lower mold, and then, as a resin is put into the molds, injection molding is conducted, so that at this time, the adhesive layer 150 of the in-mold transfer film 100 is attached to the surface of the injection product 200. After that, if the upper mold is lifted to separate the injection product 200 from the lower mold, the substrate layer 110 is separated from the hard coating layer 120, thereby finishing the process for attaching the in-mold transfer film 100 to the injection product 200, as shown in FIG. 2.

While the present invention is described with reference to the particular illustrative embodiments, it is not to be restricted by the embodiments but only by the appended claims. It is to be appreciated that those skilled in the art can change or modify the embodiments without departing from the scope and spirit of the present invention.

1. A method for fabricating an in-mold transfer film, comprising the steps of:
forming a substrate layer 110 with any one of PVC, PET and PETG;
forming a hard coating layer 120 having a given release force on top of the substrate layer;
coating a primer layer 130 on top of the hard coating layer 120 so as to strengthen the bonding force between the hard coating layer 120 and a printing layer 140 to be formed on the top of the primer layer 130;
forming the printing layer 140 on top of the primer layer 130; and coating an adhesive layer 150 on top of the printing layer 140.

2. The method according to claim 1, wherein the hard coating layer 120 comprises a composition containing slip agent, wax, and inorganic matters to apply the given release force to the surface contacted with the substrate layer 110.

3. The method according to claim 1, wherein the primer layer 130 comprises a composition containing one of acrylpolyol and urethane copolymer.

4. The method according to claim 1, wherein the printing layer 140 is formed by means of gravure printing and has a thickness between 1 μm and 5 μm.

5. The method according to claim 1, wherein the adhesive layer 150 is formed of a polyester adhesive and coated to a thickness between 1 μm and 5 μm.

6. The in-mold transfer film manufactured according to claim 1.

7. The in-mold transfer film manufactured according to claim 2.

8. The in-mold transfer film manufactured according to claim 3.

9. The in-mold transfer film manufactured according to claim 4

10. The in-mold transfer film manufactured according to claim 5.
